(19) United States
(12) Patent Application Publication
(10) Pub. No.: US 2012/0266066 A1
(43) Pub. Date: Oct. 18, 2012

(54) IMAGE DISPLAY DEVICE PROVIDING SUBJECT-DEPENDENT FEEDBACK

(76) Inventors: Ting-Yee Liao, Webster, NY (US); Timothy L. Nichols, Spencerport, NY (US); Kenneth Alan Parulski, Rochester, NY (US)

(21) Appl. No.: 13/088,473

(22) Filed: Apr. 18, 2011

(51) Int. Cl. G06F 3/048

(52) U.S. Cl. 715/716; 715/748

(57) ABSTRACT

A digital image display device for displaying a collection of digital media assets, comprising: a display screen; a network connection; a user interface for receiving input from a user of the digital image display device; and a program memory. The program memory stores executable instructions for receiving a set of digital media assets and associated metadata using the network connection; displaying a digital media asset on the display screen; identifying a subject depicted in the displayed digital media asset; determining a particular set of feedback message choices responsive to the determined subject; displaying the particular set of feedback message choices on the display screen; receiving input via the user interface to select a particular feedback message choice; and using the network connection to provide the selected feedback message.

### CROSS-REFERENCE TO RELATED APPLICATIONS

Reference is made to commonly assigned, co-pending U.S. patent application Ser. No. ______ (Docket K000099), entitled: “Image display device providing individualized feedback,” by Liao et al., and to commonly assigned, co-pending U.S. patent application Ser. No. ______ (Docket K000205), entitled: “Image display device providing feedback messages,” by Liao et al., each of which is incorporated herein by reference.

### FIELD OF THE INVENTION

This invention pertains to the field of digital media frames, and more particularly to a method for providing subject-dependent feedback for shared digital images provided over a network.

### BACKGROUND OF THE INVENTION

A digital media frame (also called a digital photo frame, a digital picture frame or a digital image display device) is a device that electronically stores and displays digital images. As used herein the term digital image includes both digital still images and digital video images. The digital images are typically captured using digital cameras (still or video), but may also be obtained using other types of digital image sources such as scanners.

U.S. Pat. No. 4,754,271 to Edwards, entitled “Liquid Crystal Photograph,” describes a device resembling a pocket calculator which stores still pictures in a digital memory cartridge and displays the pictures on a liquid crystal display (LCD) screen. The device includes an auto-sequencing mode which automatically changes the displayed image after a user-selectable time period, such as 5 seconds or 5 minutes.

Digital media frames can include a modem to receive digital images over a communications network from computers or other devices, as described in commonly-assigned U.S. Pat. No. 7,155,679 to Bandaru, et al., entitled “Digital Media Frame,” which is incorporated herein by reference. Such a digital media frame is commonly known as a “connected frame”. This patent further teaches that the connected digital media frame can include an information mode which displays news headlines, stock trading news, weather reports, and advertising received over the communications network.

Some digital media frames can receive digital images over a network from a “share group” which includes a plurality of members, as described in commonly-assigned U.S. Pat. No. 6,509,910 to Agarwal, et al., entitled “Method and system for interfacing with a digital media frame network,” which is incorporated herein by reference. This patent teaches that images provided by various sharing members can be downloaded from a network service and automatically displayed on digital media frames which communicate with the network service.

FrameChannel is an Internet service that can be used with a digital media frame having a modem which enables an Internet connection, such as a WiFi modem, that enables communication with an Internet Service Provider (ISP) via a wireless home router. A FrameChannel customer can use a home computer to access the FrameChannel website (www.framechannel.com) in order to customize the content that will be provided to their digital media frame. The customer can select from many different channels of custom content including news, traffic, weather, sports, and financial data. The customer can also use FrameChannel to receive photos from social networking or digital image sharing websites such as Facebook and Flickr and to receive photos via E-mail and camera phone messages.

The web service Facebook provides a way for individuals to share images either publicly or with friends. When viewing an image, a Facebook user is presented with a user interface allowing the association of a free form textual comment with a given image. The collection of user comments on a given image is available and visible as feedback to the owner of the image as well as other viewers.

Images may be received for display on connected digital media frames from a variety of sources and individuals. There remains a need for a method for the user of the digital media frame to provide immediate feedback appropriate to the individuals who provided the images.

### SUMMARY OF THE INVENTION

The present invention represents a digital image display device for displaying a collection of digital media assets, comprising:

a display screen;

a processor;

a network connection for receiving digital media assets, and for providing feedback related to the received digital media assets;

an image memory for storing the received digital media assets;

a user interface for receiving input from a user of the digital image display device; and

a processor-accessible program memory storing executable instructions for causing the processor to execute the steps of:
receiving a set of digital media assets using the network connection and storing the received set of digital media assets in the image memory;
displaying one of the digital media assets on the display screen;
identifying a subject depicted in the displayed digital media asset;
determining a particular set of feedback message choices responsive to the identified subject, wherein different sets of feedback message choices are determined for different identified subjects;
displaying the particular set of feedback message choices on the display screen;
receiving input from the user of the digital image display device via the user interface to select a particular one of the displayed set of feedback message choices; and
using the network connection to provide an indication of the selected feedback message.

This invention has the advantage that a user of the digital image display device can easily and quickly provide feedback appropriate to the subject of a particular digital media asset.

This invention has the additional advantage that a user of the digital image display device can select an appropriate feedback message from an automatically determined set feedback message options without the need to provide manual textual input.

It has the further advantage that the feedback message options can be customized according to the identities of the user of the digital image display device and individual who provided a particular digital media asset.

### BRIEF DESCRIPTION OF THE DRAWINGS

FIG. 1 is a high-level diagram depicting the components of a digital image display device;

FIG. 2A and FIG. 2B depict the front and back of a digital image display device;

FIG. 3 is a high-level system diagram depicting how the digital image display device of FIG. 1 communicates with other devices to receive content and configuration information;

FIG. 4A is a high level flow diagram depicting a general image display process;

FIG. 4B is a high level flow diagram depicting a general system communications process;

FIG. 5 is a flow diagram showing a method for providing an improved user interface on a digital media frame to select a feedback message in accordance with the present invention;

FIG. 6 depicts a collection of digital images stored in the digital media frame;

FIG. 7 depicts a graphical user interface for enabling a user to display images from particular individuals;

FIG. 8A is a flow diagram showing a method for providing a fixed set of feedback message choices;

FIG. 8B is a flow diagram showing a method for providing a set of feedback message choices specific to an individual who provided a displayed digital media asset;

FIG. 8C is a flow diagram showing a method for providing a set of feedback message choices specific to the subject of a displayed digital media asset;

FIG. 9A depicts a first graphical user interface providing a set of feedback message choices in accordance with the present invention;

FIG. 9B depicts a second graphical user interface providing a set of feedback message choices in accordance with the present invention;

FIG. 9C depicts a third graphical user interface providing a set of feedback message choices in accordance with the present invention; and

FIG. 9D depicts a fourth graphical user interface providing a set of feedback message choices in accordance with the present invention.

It is to be understood that the attached drawings are for purposes of illustrating the concepts of the invention and may not be to scale.

### DETAILED DESCRIPTION OF THE INVENTION

In the following description, some embodiments of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a non-transitory computer readable storage medium, which can include, for example; magnetic storage media such as a magnetic disk (e.g., a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Because digital media frames and related circuitry for providing digital interfaces, digital image storage, digital image processing, and image display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The following description of digital media frames will be familiar to one skilled in the art. It will be obvious that there are many variations of this embodiment that are possible and are selected to reduce the cost, add features or improve the performance of the digital media frame. The present invention is illustrated by way of example and not limitation in the accompanying figures.

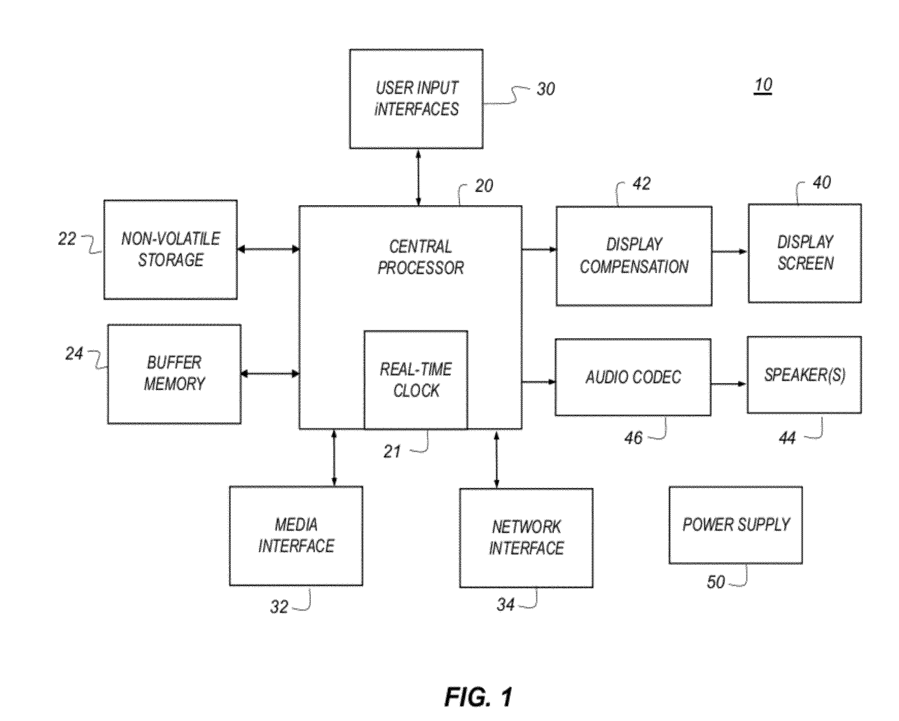

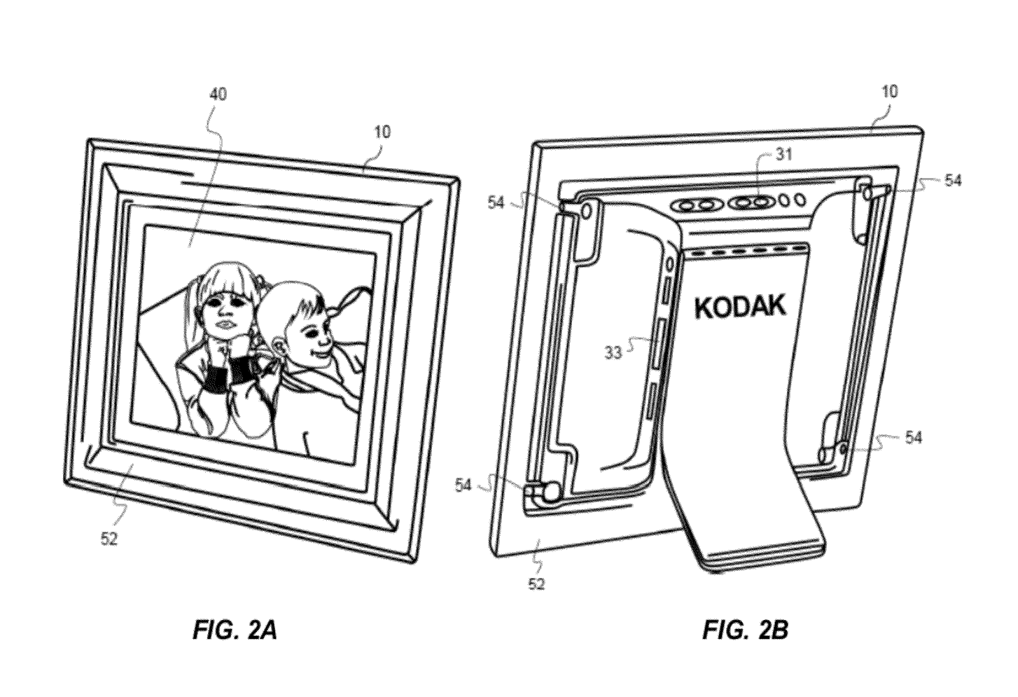

FIG. 1 is a high-level block diagram depicting an embodiment of a digital image display device 10. In a preferred embodiment, the digital image display device 10 is a digital media frame (i.e., a digital picture frame or a digital photo frame). However, in other embodiments, the digital image display device 10 can be any device having the ability to display digital media assets on a soft-copy display. Digital media assets would include both digital still images and digital video images. Examples of other types of digital image display devices 10 that can be used in accordance with the present invention would include tablet computers, personal computers, hand-held electronic devices (e.g., smart phones, PDAs or digital media players) and digital televisions. FIG. 2A depicts an embodiment of a front view of the digital image display device 10, and FIG. 2B depicts an embodiment of a rear view of the digital image display device 10. The digital image display device 10 includes a frame surround 52 which can be removed by moving the sliders 54 and replacing the frame surround 52 with a different frame surround, which may have a different color, finish, etc.

The digital image display device 10 allows a user to display digital media assets with minimal user intervention. The digital media assets to be displayed typically includes digital still images captured with a digital camera. The digital media assets to be displayed can also include video clips, graphic images, text, and animations. The digital media assets can also include audio information, such as music, speech, and sound effects.

Referring to FIG. 1, a central processor 20 in the digital image display device 10 provides the overall control of the digital image display device 10. The central processor 20 is coupled to a user input interfaces block 30, which enables a user of the digital image display device 10 to select operating modes and images to be displayed. The central processor 20 is also coupled to a media interface block 32, and a network interface block 34, which are used to provide digital media assets to the digital image display device 10. The central processor 20 is also coupled to a non-volatile storage block 22 via an interface, which provides a processor-accessible program memory that stores executable instructions that are used to control the operation of the central processor 20. Non-volatile storage block 22 can also serve as a processor-accessible image memory for storing a collection of digital media assets.

The central processor 20 is also coupled to a buffer memory block 24, which temporarily stores digital media assets for display on display screen 40. The central processor 20 is also coupled to a display compensation block 42, which processes the digital images and provides the compensated digital images to the display screen 40. The central processor 20 is also coupled to an audio codec block 46, which processes digital audio information and converts the digital audio information to one or more analog signals, which are provided to one or more speakers 44.

The user input interfaces block 30 can be provided using various conventional user input devices and circuits. For example, the user input interfaces block 30 can include a group of user buttons 31, such as those provided on the upper back of the digital image display device 10 in FIG. 2B. These user buttons 31 can include, for example, a forward function button, a reverse function button, and a pause function button. The forward function button allows the user to initiate the display of the next image in a playlist, the reverse function button allows the user to initiate the display of the previous image in a playlist, and the pause function button allows the user to initiate the continued display of the current image, until a different function button is pressed by the user. The user buttons 31 can also include a “menu” button, a “select” button” and a number of cursor movement buttons, such as “up,” “down,” “left” and “right,” or some subset thereof. These can be used to select various operating modes.

In some embodiments, the user input interfaces block 30 includes a touch screen interface provided on the front surface of the display screen 40. In some embodiments, the touch screen interface can be implemented using IR emitters and detectors in front of, and parallel to, the display screen 40. A “touch” is detected by determining which IR beams have been blocked by the viewer's finger. In some embodiments, this can be implemented using a relatively small number of emitters and detectors. For example, using 5 emitters spaced vertically and 8 detectors spaced horizontally, enables the detection of 5×8 positions on the display screen. This is enough to allow touch buttons icons to be displayed on the display screen 40 and discern which button icon was touched by the viewer.

In some embodiments, the user input interfaces block 30 includes a touch sensitive input surface that can be positioned adjacent to the display screen 40. For example, the KODAK EASYSHARE P730 Digital Frame includes two “Quick Touch Border” capacitive touch strips, including a horizontally oriented touch strip adjacent the bottom of the display screen 40 and a vertically oriented touch strip adjacent the right side of the display screen 40. Menu items are displayed on the display screen 40 adjacent to these touch strips, and the viewer touches the strip at the appropriate location in order to select menu items. One advantage of the Quick Touch Border is that it keeps fingerprints off of the display screen 40.

In some embodiments, the user input interface can also include a pointing device such as a computer mouse, a joy stick, a track ball, or a track pad. In some embodiments, the user input interface can also include a remote control input device. The remote control can include user inputs which replicate some or all of the functions provided by the user buttons 31. In some embodiments, the user input interface can also include a voice recognition interface (including a microphone and speech recognition processor) or a gesture recognition interface that includes a sensing device (such as a camera) which recognizes user hand gestures or other user movements.

Non-volatile storage block 22 represents non-volatile storage memory, which may include, for example, flash EPROM memory. Non-volatile storage block 22 provides a processor-accessible program memory for storing executable instructions, such as firmware programs, for controlling the operation of the central processor 20.

In some embodiments, the firmware programs stored in non-volatile memory block 22 can be updated or replaced by new firmware provided using the media interface block 32 or the network interface block 34. In some embodiments, other types of non-volatile memory, such as Read Only Memory (ROM), magnetic disk storage or optical disc storage, can be used. In some embodiments, the central processor 20 includes an additional program memory (not shown), and the firmware programs stored in the non-volatile storage block 22 are copied into the program memory before being executed by the central processor 20.

The non-volatile storage block 22 can also be used to provide a processor-accessible image memory for storing a collection of digital media assets such as still images, video clips, sounds music, graphics, text, and other types of content which can be used to create the images displayed on the display screen 40 and the sounds output from speaker(s) 44. These sounds can include sounds captured by the digital still or video camera when the digital images were captured. These sounds can also include sounds (such as audio annotations) captured when the images were previously viewed, either by the user or another individual. These sounds can also include songs or music soundtracks that have been associated with the digital images. In some embodiments, at least some of the stored digital media assets are associated with particular events either automatically as a result of the image capture date, or as a result of manual selection by the user. The sounds can also include audio content associated with the particular events.

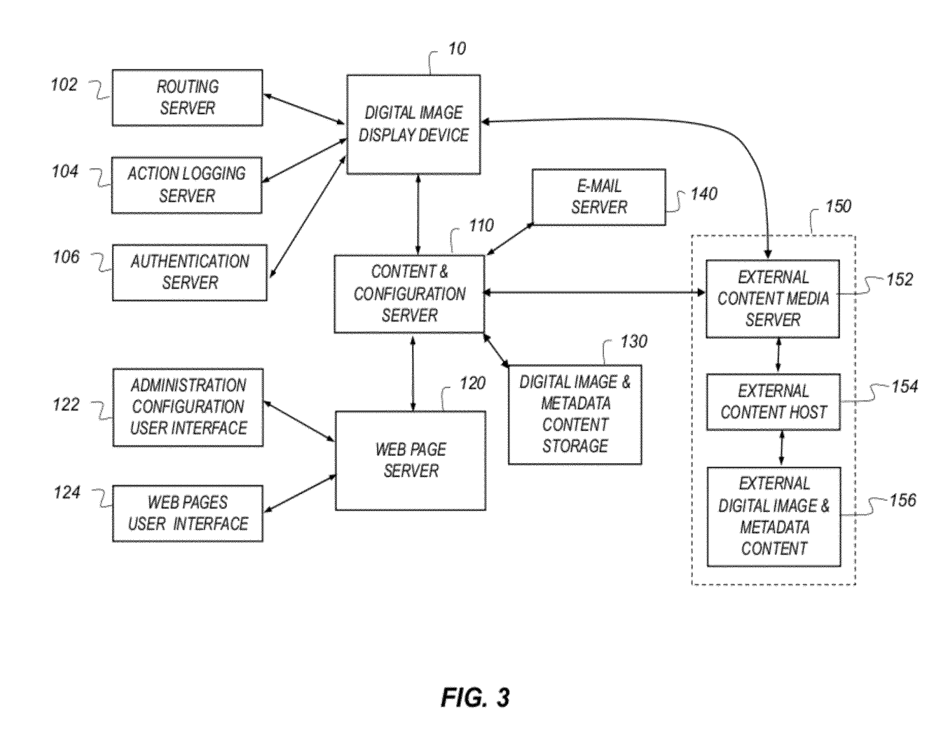

The non-volatile storage block 22 also stores auxiliary information (e.g. metadata) associated with the digital media assets. This metadata can include the date and time the image was captured by a digital capture device (e.g., a digital still camera or a digital video camera), or the date and time the image was received by the digital image display device 10. The metadata can also include data which identifies the individual or service that provided the digital media assets that was transferred to the digital image display device 10 using the system to be described later in reference to FIG. 3. The metadata can also include information relating to one or more subjects in the digital media asset, such as a type of subject (e.g., person, dog or flower), a location (e.g., Hawaii), or an identity of a particular person.

Buffer memory block 24 is a relatively small memory (compared to non-volatile storage block 22) which provides fast memory access for displaying images. The buffer memory block 24 can use, for example, one or more dynamic random access memory (“DRAM”) or static random access memory (“SRAM”) integrated circuits.

The media interface block 32 receives digital media files from various local external devices, such as removable media devices. For example, the media interface block 32 can include memory card and USB interface connectors 33 (FIG. 2B), to enable the digital image display device 10 to display media files stored on various removable Flash memory cards, such as a Secure Digital (SD) card, a micro SD card, a Compact Flash (CF) card, a MultiMedia Card (MMC), an xD card or a Memory Stick, as well as USB memory “sticks” or “jump drives”. The digital media assets stored on these memory devices can be provided by digital computers, digital still cameras, digital video cameras, camera phones, PDAs, print and film scanners, and other types of digital imaging devices. The central processor 20 controls the media interface block 32 in order to transfer media files from the local external devices. The transferred files can be stored in the non-volatile storage block 22, or can be stored directly in the buffer memory block 24 for immediate display on the display screen 40. Thus, the media interface block 32, in combination with the removable memory card or memory “stick”, provides a processor-accessible image memory for storing a collection of digital media assets, such as digital images.

The network interface block 34 can be used to enable other devices, such as computers or mobile imaging devices, to transfer digital media files to the digital image display device 10. The network interface block 34 can be provided using a wired interface, such as an Ethernet cable interface or a wired telephone modem. The network interface block 34 can also be provided using a wireless interface, such as a WiFi (e.g. IEEE 802.11 WiFi standard) modem, a cellular modem, or a Bluetooth modem.

In some embodiments, the network interface block 34 provides a direct connection to the Internet, and is configured to read HTML (“HyperText Markup Language”) and to use TCP/IP (“Transmission Control Protocol/Internet Protocol”). In other embodiments, the network interface block 34 provides a connection to a local area network, which can then provide an Internet connection using a wired or wireless router or other type of network interface device, which either interfaces directly to the Internet, or to an Internet Service Provider (ISP).

The display compensation block 42 is used to adjust the image data for the characteristics of the display screen 40. This can include tone scale adjustments, color adjustments, sharpness adjustments or any other type of appropriate adjustment. It should be noted that in some embodiments, the display compensation block 42 can be implemented by the central processor 20. In other embodiments, the display compensation block 42 and central processor 20 can be integrated into the same integrated circuit (“IC”).

The display screen 40 displays images using a soft-copy display device, such as a color active matrix LCD (“Liquid Crystal Display”). Other types of soft-copy display devices may be used, such as an OLED (“Organic Light Emitting Diode”) display, a CRT (“Cathode Ray Tube”), or various silicon-based displays.

A power supply 50 converts the AC power supplied via a wall plug to the proper DC voltages needed to provide power to all of the components of the digital image display device 10. In some embodiments, the power supply can include a re-chargeable battery, so that the digital image display device 10 can be portable, thus allowing it to be used for a period of time without a power cable, and outdoors. In some embodiments, the digital image display device 10 can include a solar panel which is used to charge the rechargeable battery.

In some embodiments, the digital image display device 10 includes a motion sensor (not shown). The motion sensor can provide a signal to the central processor 20, which controls the power supply 50 in order to supply power to the display screen 40 only when motion is detected. This reduces the power wasted when displaying images if there are no viewers in the vicinity of the digital image display device 10.

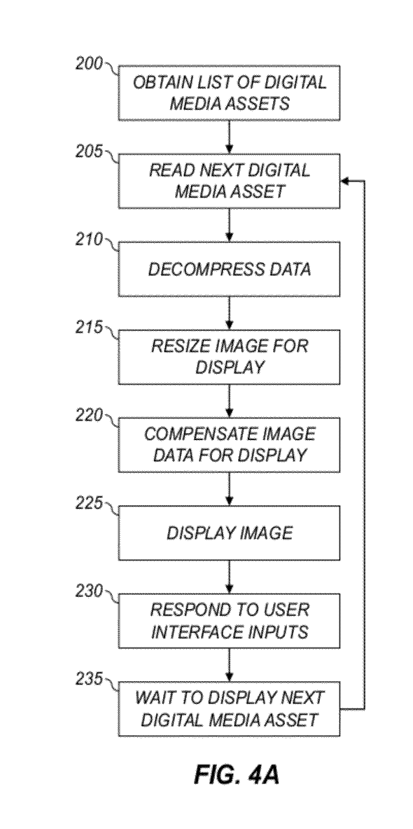

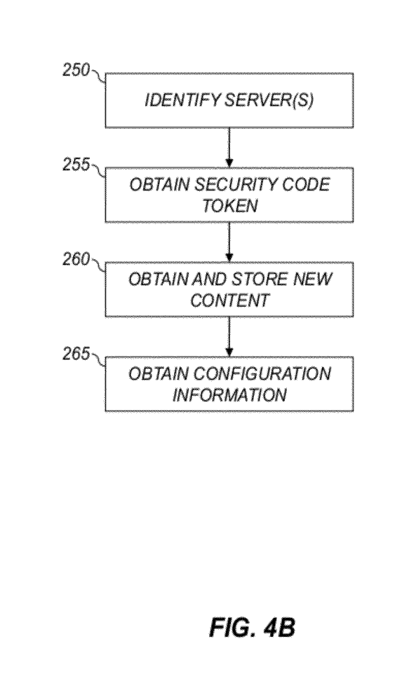

The central processor 20 runs two primary processes in order to display images and communicate with other system components, as will be described later in reference to FIG. 4A and FIG. 4B. A real-time clock 21 in the central processor 20 provides a date/time value. In some embodiments, the real-time clock 21 is manually configured by the user while in other embodiments, the real-time clock is configured using information accessed on an external device such as a Network Time Protocol (NTP) server using the network interface block 34.

It will be understood that the functions of the central processor 20 can be provided using a single programmable processor or by using multiple programmable processors, including one or more digital signal processor (DSP) devices. Alternatively, the central processor 20 can be provided by custom circuitry (e.g., by one or more custom integrated circuits (ICs) designed specifically for use in digital media frames), or by a combination of programmable processor(s) and custom circuits. It will be understood that connections between the central processor 20 and some of the blocks shown in FIG. 1 can be made using a common data bus. For example, in some embodiments the connection between the central processor 20, the non-volatile storage block 22, the buffer memory block 24, the media interface block 32, and the network interface block 34 can be made using a common data bus.

FIG. 3 is a high-level system diagram depicting an embodiment of how the digital image display device 10 can communicate over a network with other systems to receive content and configuration information. It will be understood that a large number of digital image display device 10 units, located at many different geographically dispersed locations, can be supported by the system depicted in FIG. 3. The digital image display device 10 communicates over a network (such as the Internet) with a routing server 102, an action logging server 104, and an authentication server 106. The digital image display device 10 also communicates over the network with content and configuration server 110. The content and configuration server 110 communicates with a web page server 120. The web page server 120 can be controlled by an administration configuration user interface 122 and a web pages user interface block 124. The content and configuration server 110 can obtain digital image and metadata content and store it in digital image and metadata content storage 130. The digital image and metadata content can originate into this system from an E-mail server 140, from the web page server 120 or from one or more content providing systems 150. The content providing systems 150 can provide content from a variety of sources, such as Facebook, Flickr, the Kodak Gallery, and other on-line content storage systems and services.

Each content providing system 150 can include an external content media server 152 which communicates with an external content host 154 in order to supply external digital image and metadata content 156. The external digital image and metadata content 156 can be stored on hard drives or other digital storage devices or media that can be accessed by the external content host 154.

In some embodiments, the content and configuration server 110 only provides a list of digital media assets together with appropriate information about each digital media asset. The digital image display device 10 can subsequently access digital media files directly from the content providing systems 150.

It will be understood that the various blocks shown in FIG. 3 can be implemented using different hardware configurations. For example, the routing server 102, action logging server 104 and authentication server 106 can execute on the same physical hardware, or on different hardware. Furthermore, each server, such as routing server 102, may execute on multiple pieces of hardware in order to execute operations in parallel.

FIG. 4A is a high level flow diagram depicting a general image display process performed by the central processor 20 as a foreground process. In obtain list of digital media assets step 200, the central processor 20 gets a list of digital media assets to be displayed from the non-volatile storage block 22 or from some other digital media asset storage location (e.g., storage media connected via the media interface block 32, or a remote storage location accessible via the network interface block 34). A digital media asset is a discrete piece of digital media content such as a digital still image, a digital video clip, a digital audio clip or music file, as well as graphics, text, and other types of content that can be used to create the images displayed on the display screen 40 and the sounds output from speaker(s) 44 of the digital image display device 10. A collection of digital media assets is the set of all the digital media assets that are available for display or playback on the digital image display device 10. A list of digital media assets is a list of the individual digital media assets in the collection of digital media assets. This list can be stored as a formatted text file (e.g. an XML file), as a database or in some other custom storage format. The list can be provided in the display order in which content is to be displayed, or the display order can be specified as a separate field or as a subsequent list referring back to the assets in the list. In some operating modes of the digital image display device 10, the content is intentionally displayed in a randomized order.

In read next digital media asset step 205, the central processor 20 reads the list and determines the next digital media asset to display from the list.

The central processor 20 then reads the digital media asset from the non-volatile storage block 22 or the storage media connected to media interface block 32. In some embodiments, the central processor 20 can read the digital media asset from a remote storage site via the network interface block 34.

In decompress data step 210, the central processor 20 decompresses the image data associated with the digital media asset and stores the decompressed image data in the buffer memory block 24. If the digital media asset is a video file, such as an MPEG 2 or MPEG 4 video file, the central processor 20 performs real-time decompression of the compressed video file.

In resize image for display step 215, the central processor 20 scales the image for display, by resizing the image as necessary in order to match the image size (i.e., the display screen resolution) required by display screen 40. In some embodiments, the image size stored in buffer memory block 24 is slightly larger than the screen resolution, in order to allow for some panning/zooming effects as the image is displayed.

In compensate image data for display step 220, the display compensation block 42 applies compensation to the image data before it is provided to the display screen 40. The compensation typically includes adjusting the image to account for the characteristics of the display screen 40 (e.g., an LCD panel). In some embodiments, the compensation may also adapt to the content of the specific image, for example, to provide image-specific enhancements.

In display image step 225, the central processor 20 displays the current image on the display screen 40. The central processor 20 can also display visual messages or user interface controls on the display screen 40, to indicate to the user of the digital image display device 10 various operating modes and options that can be selected by the user. In some embodiments, the central processor 20 provides these messages and controls using an on-screen graphics buffer, which can be stored in a portion of buffer memory block 24. The graphics information provided from this on-screen graphics buffer can be blended with the currently displayed image when the user activates one of the user interface elements of the user input interfaces block 30, such as a touch screen interface. In some embodiments, the text and icons are transparently overlaid on top of the currently displayed image.

In respond to user interface inputs step 230, if the user makes a selection using one of the user input elements, the central processor 20 takes one or more actions in response to the user selection. This can include, for example, changing the display time for images, deleting an image from the collection of digital media assets, or selecting a subset of the collection of digital media assets to display.

In wait to display next digital media asset step 235, the central processor waits until the real-time clock 21 has advanced by a specified time interval between images, and then execution returns to the read next digital media asset step 205. The specified time interval can be a factory default time interval (e.g., 10 seconds per image) or can be a time interval selected by the user using appropriate user interface elements. The central processor 20 also controls the type of transition between images. The transition is a mechanism of “retiring” the current image while “phasing in” the next image. For example, one type of image transition moves the current and next images in one direction (e.g. left to right, or top to bottom) such that the current image moves out while the next image moves in. In another example, the image transition fades out the current image while fading in the next image on top of the current image. Those skilled in the art will recognize that many different types of transitions can also be used.

FIG. 4B is a high level flow diagram depicting a general system communications process for secure information exchange over an insecure network, which is performed by the central processor 20 via the network interface block 34 as a background process. In some embodiments, the network interface block 34 is a WiFi wireless interface, which enables the digital image display device 10 to wirelessly communicate with various servers such as routing server 102, action logging server 104, authentication server 106 and content and configuration server 110 over a network, such as the Internet.

At startup, an identify server(s) step 250 is performed, during which the digital image display device 10 interfaces via network interface block 34 over the Internet to the routing server 102 at a known server location, in order to identify itself and determine how to proceed. The routing server 102 returns information to the digital image display device 10 that indicates which server(s) the digital image display device 10 should communicate with for all subsequent functions. The only address that is not allowed to change is the path to this routing server 102.

In obtain security code token step 255, the digital image display device 10 uses a secure communication method (e.g., https://) to query the authentication server 106 for a security code to communicate with the rest of the system. This query involves transmission of private information that is known by both the digital image display device 10 and the authentication server 106. The authentication server 106 generates a temporary security token and returns the token to the digital image display device 10. The token is made available to other parts of the server (and other servers) to allow authentication of the particular digital image display device 10 for future operations.

When the time window for the authentication token expires, any operations from the digital image display device 10 to one of the servers (other than the authentication server 106) will be rejected. In this situation, the digital image display device 10 then communicates with the authentication server 106 in order to acquire a new authentication token, before continuing with other operations. The use of a temporary token for most of the communications between the digital image display device 10 and each of the servers has the advantage of minimizing exposure to the private information shared between the digital image display device 10 and the authentication server 106 and the advantage of minimizing the computation required for subsequent communications by reducing the need for secure communications with a temporary token.

In obtain and store new content step 260, the digital image display device 10 communicates with the content and configuration server 110 in order to retrieve any new content that may be available. The digital image and metadata content provided by the content and configuration server 110 is organized into groups of pictures that are grouped by some combination of the source of the content (e.g., E-mail, Facebook or Kodak Gallery), a unique identifier of the sender of that content (e.g., the E-mail address of the sender who provided the content), and the date and time that the particular content was shared (or the instance of sharing). In some embodiments, a direct network upload sharing method can be used to provide content directly to the digital image display device 10. The direct upload sharing method can make use of various interfaces such as the well-known FTP or REST interfaces.

The digital image and metadata content provided by the content and configuration server 110 may also be organized by other information related to each particular content such as the location where the particular content was captured, keywords associated with the particular content, names or identity of people captured in the particular content, or things captured in the particular content.

The digital image and metadata content is obtained through a separate interface to content and configuration server 110, and is stored using an appropriate non-volatile storage (not shown) available to the content and configuration server 110. The content and configuration server 110 sends a description of the new content to be stored on the digital image display device 10. The central processor 20 in the digital image display device 10 then individually retrieves each of the digital media assets defined by the content and configuration server 110 and stores each digital media asset in the non-volatile storage block 22 in the digital image display device 10. The digital image display device 10 also transfers metadata related to each digital media asset, such as the sharing method (e.g., E-mail, Facebook or Kodak Gallery), an identifier for the individual providing the digital media asset, an identifier of the sharing instance, and any descriptive text available related to the digital media asset. In some embodiments, the digital media assets are only downloaded from the content and configuration server 110 at the time when they are to be displayed on the digital image display device 10, and are not stored locally in the non-volatile storage block 22 in the digital image display device 10. In some embodiments, the digital media assets are stored in non-volatile storage block 22 using a cache mechanism and the digital media assets are retrieved from the non-volatile storage block 22 if the digital media asset is stored in the non-volatile storage block 22 and has not been updated on the content and configuration server 110, and further, if the digital media asset is not stored in the non-volatile storage block 22 the central processor 20 retrieves the digital media asset from the content and configuration server 110 and stores the asset into the cache mechanism stored on the non-volatile storage block 22. The details of the data cache mechanism will be familiar to one knowledgeable in the arts.

The user can add content to the digital image display device 10 by using a web browser upload sharing method via the web pages user interface block 124 to upload digital images and other digital media assets to the web page server 120. The web page server 120 then stores these digital media assets and appropriate metadata.

In obtain configuration information step 265, the digital image display device 10 communicates with the content and configuration server 110 in order to retrieve configuration information. The configuration information includes settings such as the type of slideshow transition, the time interval for displaying each slideshow image, and the time of day to automatically turn the digital image display device 10 on and off.

In some embodiments, factory default configuration information is stored on the content and configuration server 110 automatically when a digital image display device 10 is registered. The user can utilize the web pages user interface block 124 to modify the configuration information. Additionally, configuration information can be modified by a system administrator using the administration configuration user interface 122, in order to address any service related issues or to provide updates.

The user can use the web pages user interface block 124 to permit E-mail transfer of digital media assets to their particular digital image display device 10. In this case, the user enters a specific E-mail address to enable content to be sent to their digital image display device 10. When E-mail is sent (typically by others) to that address on the E-mail server 140, the digital images and other relevant content is extracted from the E-mail and transferred to the digital image and metadata content storage 130. Metadata about the sender, sharing date, etc. is also stored in association with this content.

The user can also use the web pages user interface block 124 to configure their digital image display device 10 to receive digital media assets that are provided from one or more content providing systems 150 through various external services on the Internet. There are two primary mechanisms for how content is transferred from the external content providing systems 150, depending on how the external system operates.

In a first “pull” mechanism, the content and configuration server 110 periodically polls the external content media server 152 to determine whether new external digital image and metadata content 156 is available from external content host 154. If new content is available, the content and configuration server 110 retrieves the metadata for the new content and stores it in the digital image and metadata content storage 130. The original digital media asset data (e.g., still digital image or digital video file) is not transferred. When the digital image display device 10 later retrieves the list of digital media assets to retrieve, the URL for this new digital media asset will point back to the corresponding external content media server 152.

In a second “push” mechanism, the external content media server 152 provides a notification when new external digital image and metadata content 156 is available from external content host 154. In this case, the content and configuration server 110 configures the external content media server 152 to provide a notification whenever relevant additions or changes are made for the content requested. The external content media server 152 then notifies the content and configuration server 110 when content is added, modified or removed. The content and configuration server 110 then updates the digital image and metadata content stored on the digital image and metadata content storage 130 to reflect the new state of the external content providing systems 150. It will be understood that the content and configuration server 110 stores configuration information for a large number of digital image display device 10 units, and that each digital image display device 10 can be configured to permit content to be provided from a number of different external content providing systems 150 (such as Facebook, Flickr, Kodak Gallery, etc.) using “pull” or “push” mechanisms. The obtain and store new content step 260 and the obtain configuration information step 265 are repeated at regular intervals (e.g., every ten minutes) in order to obtain new content for digital image display device 10. In another embodiment, the obtain configuration information step 265 can be initiated by a message being “pushed” from the content and configuration server 110 to the digital image display device 10 that indicated new or updated content may be available on the content and configuration server 110.

In some embodiments, the digital image display device 10 has an “informational” mode as well as a “pictorial digital media asset” mode. The informational mode of digital image display device 10 displays various information, such as news headlines, financial data, advertising, and the like. The information can be displayed instead of, or along with, the pictorial digital media assets. In the latter case, the digital image display device 10 dedicates a portion of the display screen 40 to pictorial display while another portion of the screen is apportioned to informational display. The informational display can be located adjacent to the pictorial display, or can be overlaid on top of the pictorial display. The information to be displayed can be provided using the system depicted in FIG. 3. The types of information to be provided can be configured for a particular user of digital image display device 10 by using the web pages user interface block 124 to select the particular information of interest to the user. This can include information about particular stocks, sport teams, weather reports, news categories, shopping, gambling, etc., which are of interest to the user. In some embodiments, the information can be provided by various information content web servers (not shown) which provide content to the content and configuration server 110. In other embodiments, the digital image display device 10 can communicate directly with the external web sites (not shown) that provide the information, in order to receive and display web pages, using a web browser implemented in the digital image display device 10.

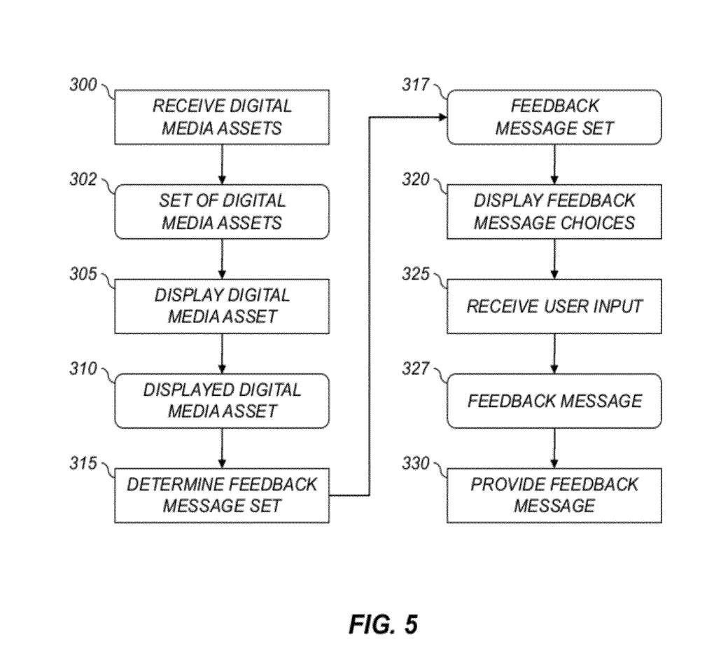

FIG. 5 is a flow diagram showing a method for providing an improved user interface to select a feedback message on the digital image display device 10, wherein the feedback message is provided to the individual who shared the digital media asset. In receive digital media assets step 300, the digital image display device 10 receives a set of digital media assets 302 together with associated metadata. Generally, the set of digital media assets 302 will be received from a plurality of individuals using one or more sharing methods. The set of digital media assets 302 is received using the network connection provided by the network interface block 34. The received set of digital media assets 302 and metadata are stored in a memory of the digital image display device 10, for example using the non-volatile storage block 22 or using a storage media attached to media interface block 32.

According to one sharing method, the user can use the web pages user interface block 124 to provide an E-mail address for their digital image display device 10. This E-mail address can then be sent to friends and family members. The friends and family members can send E-mails to this E-Mail address, and the E-mails will be received by E-mail server 140. The E-mails can include digital media assets, such as digital still images. E-mails sent by different individuals to the E-Mail address for the digital image display device 10 are designated as being provided by different sources. In some embodiments, the particular source can be identified by the E-mail address (e.g., a “sent by” or a “reply to” address) that was used to send the E-mail. The content and configuration server 110 can then use the “sent by” or “reply to” address in order to automatically identify the individual who provided a particular digital media asset.

The identity of the individual who provided particular digital media assets is stored as metadata associated with the particular digital media assets in digital image and metadata content storage 130. It will be understood that each E-mail can provide a single image, or a plurality of images. The content and configuration server 110 can also store metadata which identifies the E-mail message that provided the digital media assets, so that a plurality of images provided by the same E-mail message can be associated together as a single “sharing instance.”

According to another sharing method, the user can use the web pages user interface block 124 to enable their digital image display device 10 to receive digital media assets that are provided from one or more content providing systems 150, using various external services on the Internet. For example, the user can select the Kodak Gallery website, or a website associated with other on-line content storage systems and services. In addition to selecting the content providing system, the user can use web pages user interface block 124 to select the account name(s) used to store the digital media assets that are to be provided to the digital image display device 10. In some embodiments, the user can use the web pages user interface block 124 to select digital media assets matching additional search criteria in order to select only a subset of the digital media assets associated with a particular account name. Examples of search criteria that can be used in accordance with the present invention would include search criteria to identify digital media assets included in a specified album, digital media assets associated with a specified keyword, digital media assets that include one or more specified persons or objects, digital media assets that were captured at a specified capture location, digital media assets that were captured within a specified date range, digital media assets that were received within a specified date range, or digital media assets that were received with a specified sharing method.

The content providing systems 150 selected by user can include, for example, social networking websites such as Facebook and MySpace, or digital image sharing websites such as Kodak Gallery or Snapfish. In some embodiments, the user can use web pages user interface block 124 to select particular “friends”. The assets that these “friends” upload to their account on the social network website can then be automatically provided to the digital image display device 10 under the control of content and configuration server 110. It will be understood that the “friend” on the social network website serves as the individual who provided the digital media assets associated with their account.

In some embodiments, the digital image display device 10 can be in continuous communication with the content and configuration server 110. In other embodiments, the digital image display device 10 can instead connect and communicate with the content and configuration server 110 on an occasional basis, for example every ten minutes, or every hour, or when digital media assets are pushed down from the content and configuration server 110.

The digital image display device 10 receives digital media assets (e.g., digital still images and digital video images) and metadata from the content and configuration server 110 via the network interface block 34, and stores the digital media assets and metadata in the non-volatile storage block 22, or using a storage media attached to media interface block 32. The metadata can be stored using a variety of formats. For example, the metadata can be included in the image files, or can be stored separately from the image files (such as in a database file), or can be stored both in the image files and in a separate database. The metadata enables the stored digital media assets to be grouped according to the individual “source” that supplied the asset. The metadata also enables the stored digital media assets be grouped according to their origin/sharing method (upload, E-mail, Facebook, Kodak Gallery, etc.). The metadata also enables the stored assets to be grouped according to an “album” or a “sharing instance”.

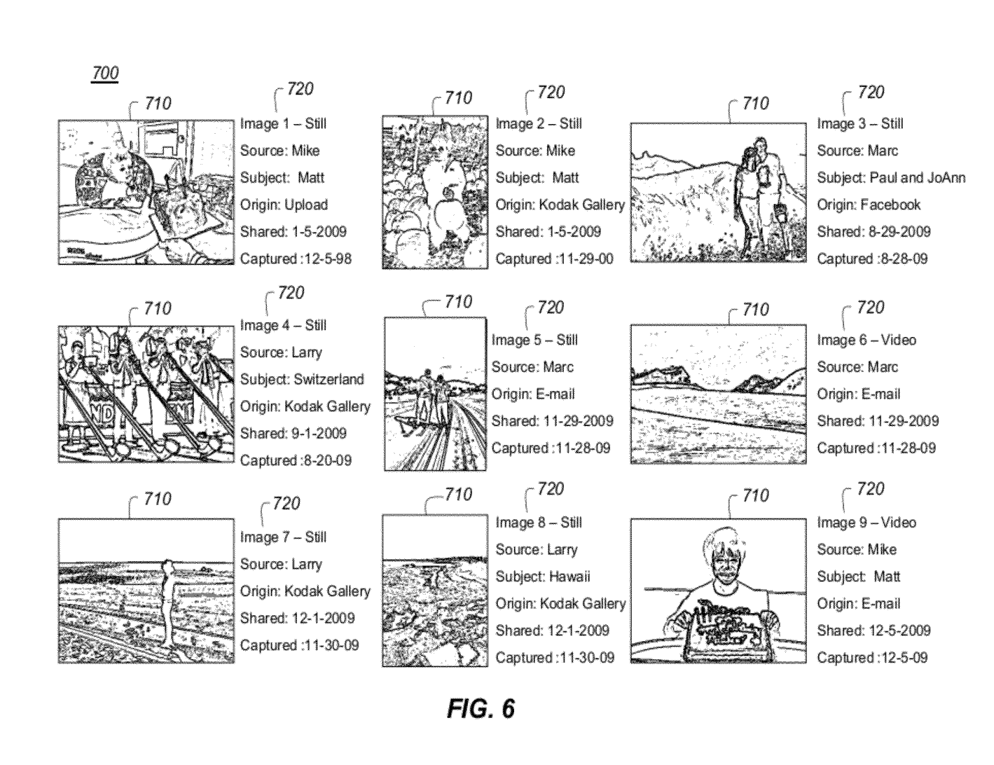

FIG. 6 depicts a collection of digital media assets 700 stored in the digital image display device 10, including nine particular digital media assets 710, and some of the associated metadata 720. The digital media assets 710 include two digital video clips (Images #6 and #9) and seven digital still images (Images #1-#5 and #7-#8). It will be understood that the digital image display device 10 typically stores a much larger number of digital media assets 710, for example several hundred or several thousand digital media assets 710.

Each of the digital media assets 710 depicted in FIG. 6 has associated metadata 720. The metadata 720 includes a digital media asset identifier (e.g., “Image 1”), and a digital media asset type (e.g., “still” or “video”). The metadata 720 also includes a digital media asset source (“Source”) providing an indication of the individual who provided the digital media asset (e.g., “Mike” or “Larry”), and a digital media asset sharing method (“Origin”) providing an indication of the sharing method by which the digital media asset was provided. For example, sharing methods can include an E-mail sharing method (i.e., “E-mail”), social networking website sharing methods (e.g., “Facebook”), digital image sharing website sharing methods (e.g., “Kodak Gallery”), web browser upload sharing methods or direct network upload sharing methods. The metadata 720 also includes a sharing date (“Shared”), which provides the date on which the digital media asset was transferred to the digital image display device 10, as well as a capture date (“Captured”), which is the date that the digital media asset 710 was captured by a digital camera, or scanned by a digital image scanner. The capture date metadata can be provided, for example, by the date/time metadata included in the well-known Exif-JPEG image format when the digital media asset 710 was captured by a digital camera.

The metadata 720 for some of the digital image assets 710 also includes subject metadata (“Subject”), which indicates the subject or subjects depicted in the digital image asset. The subject metadata can include, for example, the names of people pictured in the digital media assets 710. For example, “Matt” is the subject metadata for image #1, image #2, and image #9. The names of the people can be provided either manually (e.g., by the users who shared the digital image assets), or can be determined automatically using a face recognition algorithm. In some embodiments, the face recognition algorithm can be implemented using the central processor 20 in the digital image display device 10. In other embodiments, the face recognition algorithm can be implemented in the content and configuration server 110 or in some other external computing system. The subject metadata can also include the names of objects pictured in the digital media assets 710, such as “dog” or “flower.” The names of the objects can be provided either manually (e.g., by the users who shared the digital image assets), or can be determined automatically using object recognition algorithms. The subject metadata can also include capture locations for the digital media assets 710, such as the “Switzerland” subject metadata for Image #4. The location metadata can be provided either manually (e.g., by the users who shared the digital image assets), or can be determined automatically. For example, if the digital image asset was captured using a device such as a smart phone that included a GPS receiver, the geographical location can be automatically determined and stored as metadata in association with the digital media asset.

It will be understood that many other types of metadata 720 can also be stored in association with the digital media assets 710 stored in the digital image display device 10. The metadata 720 can include album names, event names, captions, keywords and the like. Additionally, the metadata may include comments or feedback associated with the digital image. The feedback messages may have been supplied locally in the digital image display device 10, or may have been supplied by individuals using other systems such as Facebook or Flickr through the content providing system 150.

In display digital media asset step 305, the digital image display device 10 displays one of the digital media assets in the set of digital media assets 302 on the display screen 40, thereby providing a displayed digital media asset 310. The displayed digital media asset can be the last digital media asset received by the digital image display device 10. Alternatively, the displayed digital media asset can be displayed as part of an asset display sequence, or can be manually selected by the user of the digital image display device 10 using a graphic user interface that permits users to select particular digital media assets, or groups of digital media assets. For example, the graphic user interface may permit the user to select all digital media assets provided by a specific individual.

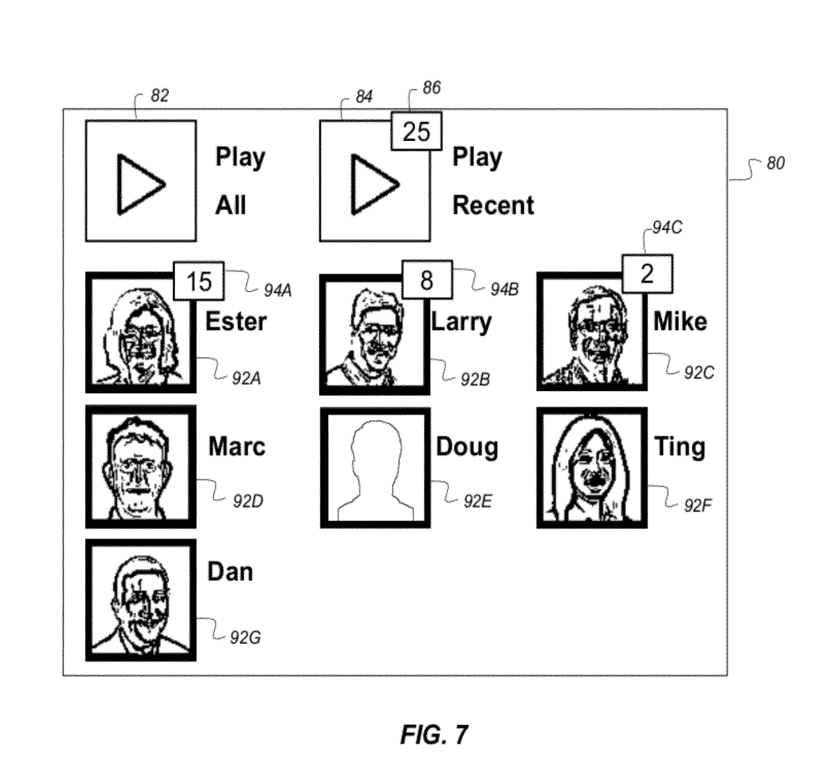

FIG. 7 shows an example of a graphical user interface 80 which can be displayed on the display screen 40 (FIG. 1). The graphical user interface 80 includes a play all icon 82, which can be selected by the user in order to display all of the digital media assets stored in the digital image display device 10. The graphical user interface 80 also includes a play recent icon 84, which can be selected by the user in order to display only those assets which have recently been received by the digital image display device 10. The time period for determining recently received images can be a factory default value (e.g., digital media assets received during the last 10 days), or can be a time period selected by the user in association with obtain configuration information step 265. The method for determining recently received images can also be specified by a number of most recently received digital media assets to display (e.g., the last 100 digital media assets received), which could be a factory default value or a value selected by the user association with obtain configuration information step 265. The number of recently received digital media assets is displayed in recently received assets box 86.

The example graphical user interface 80 shown in FIG. 7 includes seven person icons 92A-92G, which represent the seven different individuals who have been the source of the digital media assets currently stored in the digital image display device 10. An icon can include a small photo of the individual, such as the photo of Ester used for person icon 92A. The photos for the various individuals can be uploaded or selected by the user of the digital image display device 10, using the web pages user interface block 124, when the user enables the digital image display device 10 to receive digital media assets from the individuals (e.g., as described earlier with respect to the receive digital media assets step 300). In some embodiments, the photos for the various individuals can be determined automatically. For example, the photo for an individual who is enabled to provide images from a Facebook account can be derived from the individual's Facebook page profile image. In some embodiments, the central processor 20 in the digital image display device 10 can enable the user to select and crop one of the stored digital still images in order to provide a small photo of an individual who has provided digital media assets. If a photo of a particular individual is not available, a generic icon can be used, such as person icon 92E.

It will be understood that in order to display a larger number of person icons (e.g., 30 icons) for a larger number of individuals, a subset (e.g., 9 person icons) of the total number of person icons can be displayed at a time, along with appropriate navigation icons that enable the user to scroll through the larger number of person icons.

In some embodiments, the person icons 92A-92G can be displayed using an order such that individuals who have most recently shared digital media assets are shown nearer the top of the graphical user interface 80. In some embodiments, the number of digital media assets recently received from each individual can be displayed, as shown in recently received assets boxes 94A, 94B, and 94C, which are associated with the corresponding person icons 92A, 92B, and 92C, respectively. For example, recently received assets box 94C indicates that two digital media assets have been recently received from Mike.

In some embodiments, the digital image display device 10 also stores a set of “feedback photos” for one or more users of the digital image display device that can be used to provide various types of feedback through their expressions or gestures. For example, the set of feedback photos can include photos of the user smiling, frowning, giving a “thumbs up” gesture, and giving a “thumbs down” gesture. As will be described later, the set of feedback photos can be used to provide feedback to the individuals who provided the digital media assets. The set of feedback photos can be uploaded or selected by the user, using the web pages user interface block 124, during a configuration process for the digital image display device 10.

It will be understood that some embodiments can also include graphical user interface elements that enable the user to select digital media assets that include particular people, albums, stories, events, or capture time periods. This can enable the user to select a subset of the digital media assets provided by a particular individual for display. For example, after the user selects one of the person icons 92A-92G, an additional graphical user interface can be invoked to enable the user to select a particular album name, a capture time period, or the like. In such an embodiment, only the digital media assets from the selected individual that are associated with the selected album or time period will then be displayed, unless the user subsequently overrides this selection by selecting a “display all” icon in order to display all images from the selected individual.

Returning to a discussion of FIG. 5, in determine feedback message set step 315, the central processor 20 in the digital image display device 10 determines a feedback message set 317 including a particular set of feedback message choices appropriate for a displayed digital media asset 310. In some cases, the feedback message set 317 may be the union of multiple sets of feedback message choices. The determination of feedback message set 317 is responsive to one or more feedback message set criteria. The feedback message set criteria will typically be stored in the non-volatile storage block 22. Such feedback message set criteria can be defined during the configuration of the digital image display device 10 or may be dynamically generated responsive to the current state of the digital image display device 10, or responsive to data acquired over the network interface block 34. Such feedback message set criteria are used to determine the feedback message set 317.

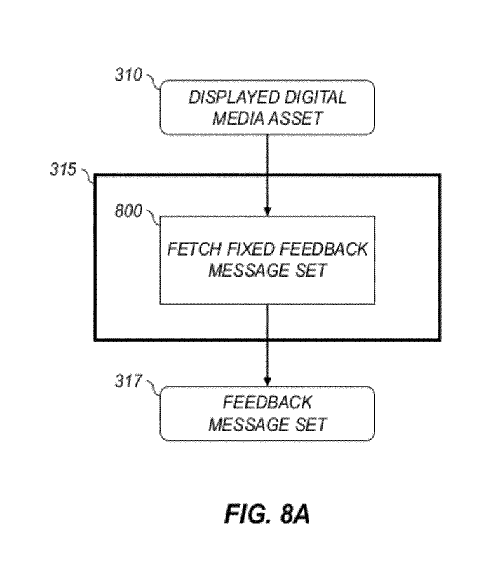

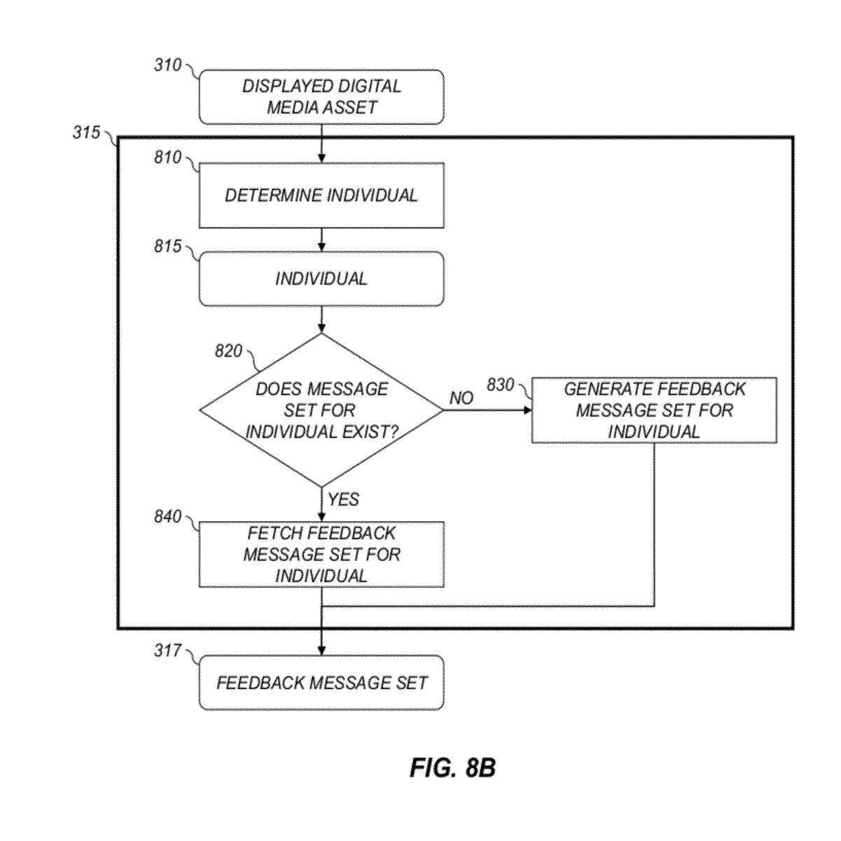

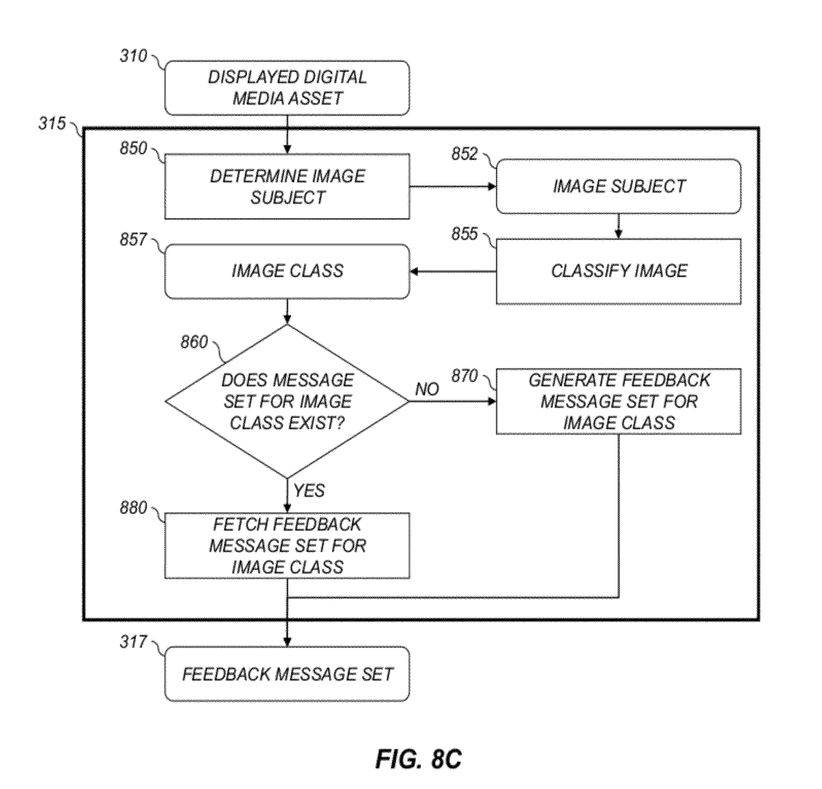

FIG. 8A, FIG. 8B, and FIG. 8C, depict three possible embodiments of the determine feedback message set step 315. One skilled in the art would recognize that a particular digital image display device 10 may be configured to use a single method to determine a single set of feedback message choices, or may be configured to use combinations of methods to determine multiple sets of feedback message choices where the result of the determine feedback message set step 315 is the union of the sets of feedback message choices determined by the multiple methods.

In fetch fixed feedback message set step 800 of FIG. 8A, a feedback message set 317 that is universal for all digital images is selected. In some embodiments, the method of FIG. 8A is used to provide a basic set of feedback messages that are appropriate for all digital media assets. The basic set of feedback messages can then be supplemented with additional feedback messages that may be selected responsive to the particular displayed digital media asset 310. In other embodiments, the method of FIG. 8A is used to provide a default set of feedback messages for digital media assets where no information about the individual who provided the particular displayed digital media asset 310, or about the content of the particular displayed digital media asset 310, is associated with the particular displayed digital media asset 310.

FIG. 8B illustrates an embodiment of the determine feedback message set step 315 where the feedback message set 317 is determined responsive to the individual who shared the displayed digital media asset 310. In determine individual step 810, the individual 815 who shared the displayed digital media asset 310 is fetched from the metadata associated with the displayed digital media asset 310.

In does message set for individual exist test 820, the central processor 20 in the digital image display device 10 attempts to locate a previously generated feedback message set associated with the determined individual. If a previously generated feedback message set exists, a fetch feedback message set for individual step 840 is used to provide the feedback message set 317. The previously generated feedback message set may be located in the non-volatile storage block 22 or available from a network server that can be accessed over the network interface block 34. In some embodiments, the previously generated feedback message set may be associated with a group of individuals rather than a particular individual. For example, there can be on previously generated feedback message set for family members, and another for college friends. If the particular individual is determined to belong to one of the groups of individuals, then the previously generated feedback message set associated with that group can be used. In some embodiments, a database can be used to determine a relationship between the user of the digital image display device 10 and the individual who provided the digital media assets. The determined relationship can then be used to select an appropriate previously generated feedback message set.

If a previously generated feedback message set for the determined individual is found, then it is provided as the feedback message set 317. The previously generated feedback message set may include feedback messages that were used while the user was using the digital image display device 10, or while the user was using some feedback providing system other than the digital image display device. The previously generated feedback message set may also include feedback messages that were provided to the individual by other users different than the user of the digital image display device 10.

If a previously generated feedback message set for the determined individual is not found, then a generate feedback message set for individual step 830 is used to generate a new feedback message set. The new feedback message set is provided as the feedback message set 317, and can be stored for use with future digital media assets that are provided by the same individual.

In one embodiment, the generate feedback message set for individual step 830 is performed by the central processor 20 in the digital image display device 10. In another embodiment, the generate feedback message set for individual step 830 is performed by requesting over the network interface block 34 that a remote system generate the new feedback message set.

Embodiments of the generate feedback message set for individual step 830 can determine the new feedback message set using various methods. In various embodiments, the process of determining the new feedback message set can include an analysis of previous feedback messages associated with other digital media assets shared by the determined individual 815, an analysis of the relationship of the user to the determined individual, a frequency analysis of words or phrases, a heuristic analysis, or a natural language processing operation. Some of these embodiments will require identification of the current user of the digital image display device 10, which may be accomplished by use of supplied login credentials, fingerprint scanning, facial recognition, or other user identification means (not shown) that may be available to the digital image display device 10. For example, in some embodiments the digital image display device 10 can include an image capture device, and the identity of the user of the digital image display device 10 can be determined by applying a face recognition algorithm to an image of the user captured using the image capture device.

It will be understood that the individual who provided the digital media asset may be a member of a group of individuals, and the same set of feedback message choices can used for digital media assets provided by all members of a particular group. Examples of groups of individuals that could use a common set of feedback message choices would include a group of work colleagues, a group of college friends, or an affinity group having a common interest (e.g., members of a fan club). In this case, the particular set of feedback message choices is determined by determining a group of individuals that includes the individual who provided the displayed digital media asset. In some embodiments, the particular set of feedback message choices is determined by determining a group of individuals that includes both the user of the digital image display device 10, as well as the individual who provided the displayed digital media asset.

In FIG. 8C, the feedback message set 317 is determined responsive to a classification of the subject of the displayed digital media asset 310. In some embodiments, the determine image subject step 850 determines the image subject 852 by analyzing the displayed digital media asset 310 or metadata (e.g., the metadata 720 in FIG. 6) associated with the displayed digital media asset 310. For example, in some embodiments, the image subject can be determined by analyzing the displayed digital media asset 310 with automatic algorithms such as face recognition algorithms, object recognition algorithms, geographical location recognition algorithms and image classification algorithms. In some embodiment, the metadata provides information directly identifying the subject of the displayed digital media asset 310, which can be, for example, the names of one or more persons depicted in the displayed digital media asset 310, the names of one or more objects depicted in the displayed digital media asset 310, or the location where the displayed digital media asset 310 was captured.

In classify image step 855, the metadata is analyzed to determine an image class 857 for the displayed digital media asset 310. Examples of images classes may include a birthday class, a beach vacation class, a flowers class, a children class, an animals class, or a scenic vista class. In some embodiments, the image subject 852 can be used directly as the image class 857. For example, if the image subject 852 is a particular person “Matt,” a corresponding image class 857 could be defined corresponding to images containing Matt.

In some embodiments, the classify image step 855 can supplement the image subject 352 with other information such as the metadata 720 and other ancillary data, such as data associated with friends and family members. This ancillary data can include, for example, birthdays and anniversary dates for particular friends and family members, which can be used to help classify some of the digital media assets 710. For example, the metadata 720 associated with Image #9 in FIG. 6 indicates that this digital media asset was captured on Dec. 5, 2009 and that the subject is “Matt”. If the ancillary data indicates that Matt's birthday is December. 5, the metadata 720 can be used to classify this digital media asset as a picture of Matt taken on his birthday. In this example, the displayed digital media asset 310 can be classified as belonging to multiple image classes 857 (i.e., an images containing Matt class, and a birthday class).

In does message set exist for image class test 860, the central processor 20 in the digital image display device 10 attempts to locate a previously generated feedback message set associated with the identified image class 857. The feedback message set may be located in the non-volatile storage block 22 or retrieved over the network interface block 34. If a feedback message set for the image class is found, then a fetch feedback message set for image class step 880 is used to retrieve the feedback message set 317.

If a feedback message set for the image class is not found, then the method proceeds to a generate feedback message set for image class step 870. In one embodiment, the generate feedback message set for image class step 870 is performed by the central processor 20 in the digital image display device 10. In another embodiment, the generate feedback message set for image class step 870 is performed by requesting over the network interface block 34 that a remote system generate the feedback message set 317.

Embodiments of generate feedback message set for image class step 870 may include analysis of previous feedback messages left for other digital media assets of the same image class 857, frequency analysis of words or phrases, heuristic analysis, or natural language processing.

Returning now to a discussion of FIG. 5, a display feedback message choices step 320 is used to display the feedback message set 317 on the display screen 40 (FIG. 1). Accordingly, different sets of feedback message choices are displayed responsive to the feedback message set criteria (e.g., responsive to the determined individual 815 (FIG. 8B) or the image subject 852 (FIG. 8C)). A receive user input step 325 receives input from the user of the digital image display device 10, using user input interfaces block 30, to select a particular feedback message 327 from the displayed feedback message set 317. An indication of the selected feedback message 327 is then provided to the individual who provided the displayed digital media asset 310, or to an account associated with that individual, using a provide feedback message step 330.

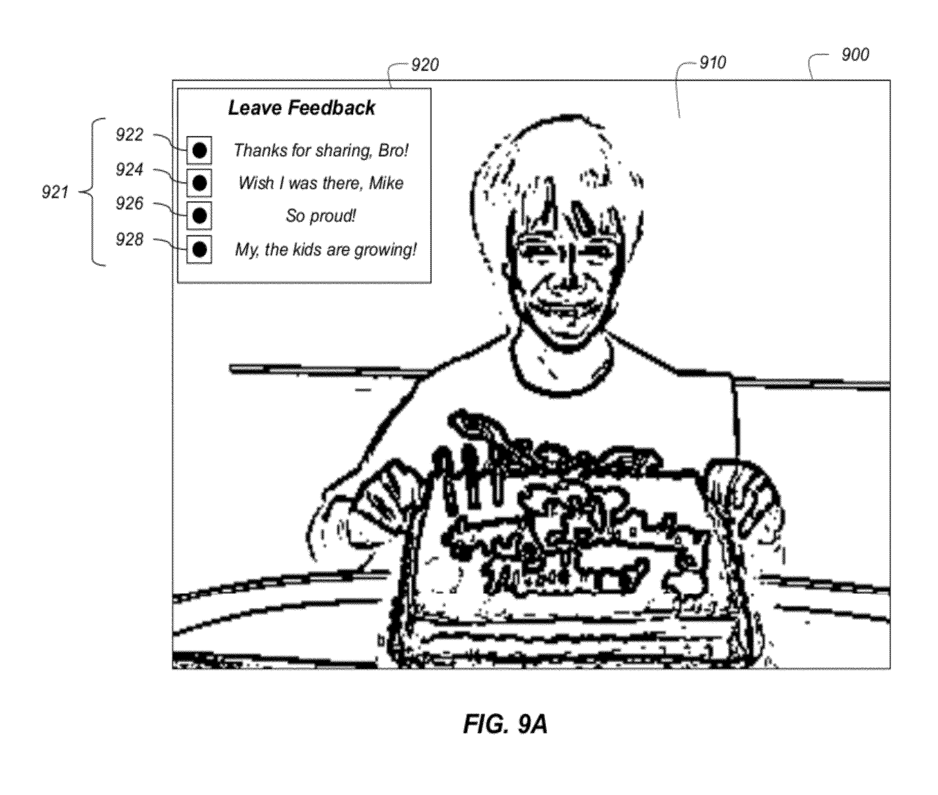

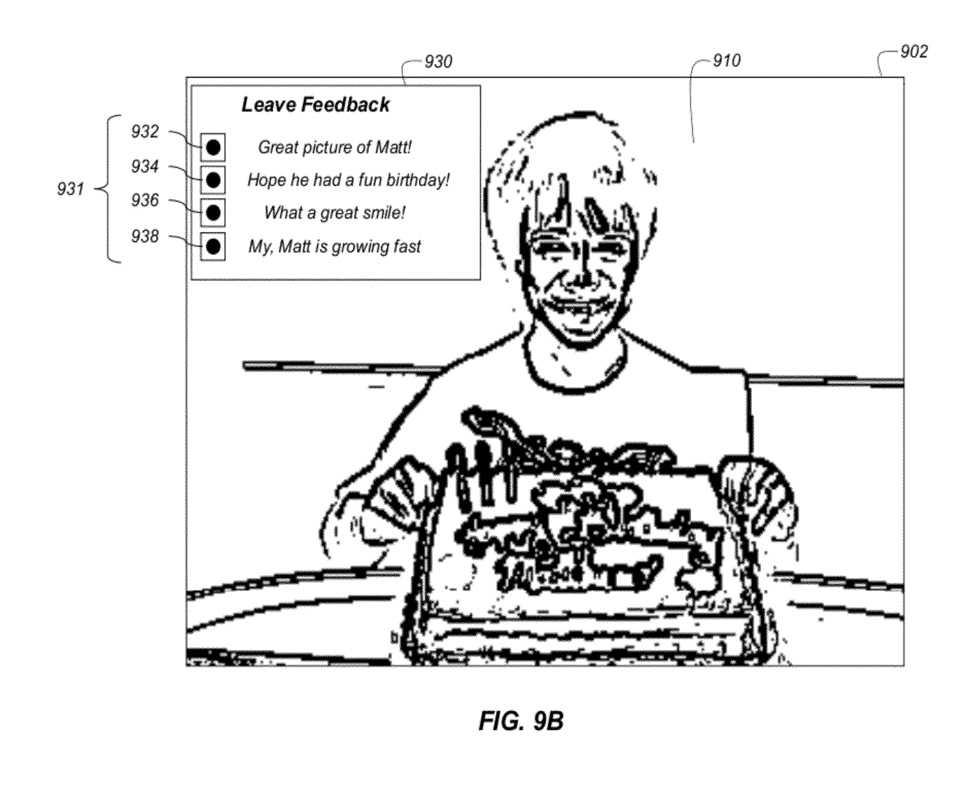

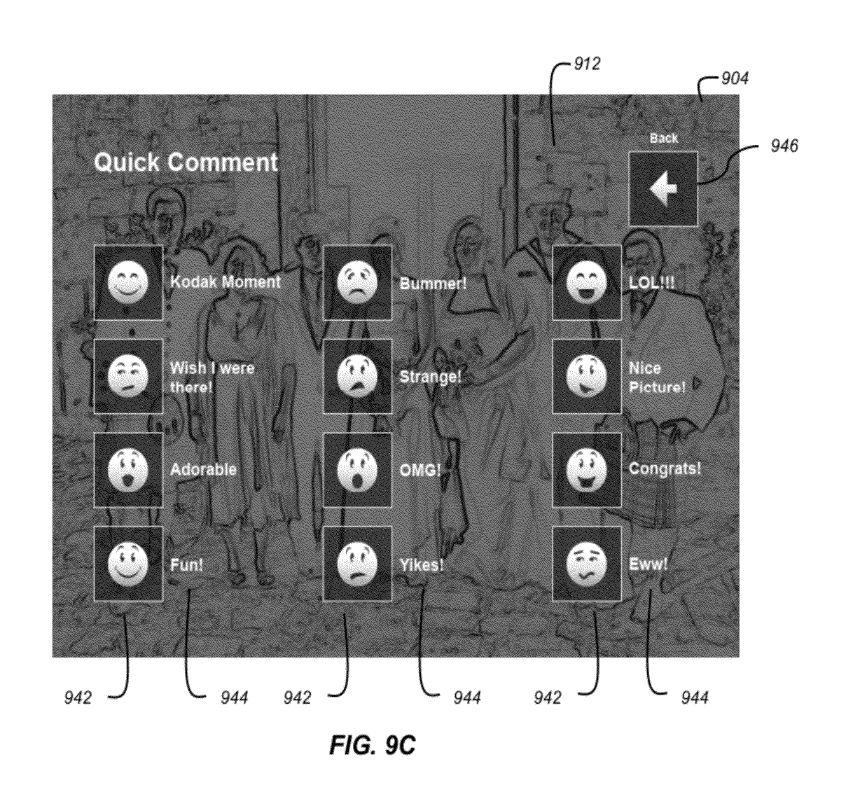

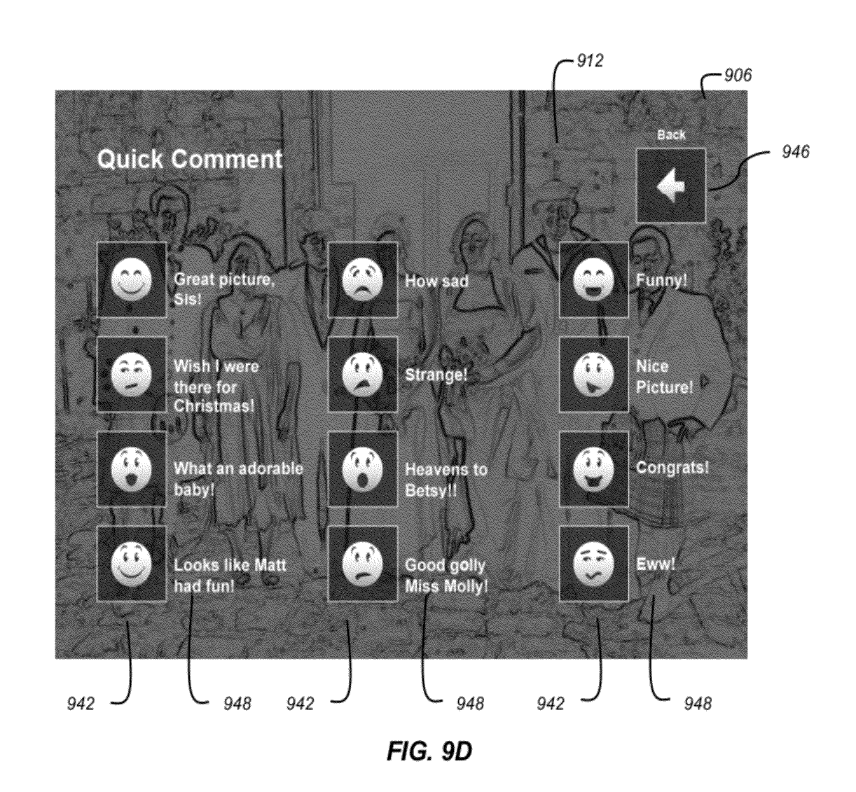

FIGS. 9A-9D depict four examples of graphical user interfaces for displaying a feedback message set 317 including a set of feedback message choices in accordance with the present invention. FIG. 9A depicts a first example of a user interface 900 which is used to display a particular feedback message set 921 on the display screen 40. The user interface 900 also includes a displayed digital media asset 910, for which the feedback message can be provided. The particular feedback message set 921 includes feedback message choices 922, 924, 926 and 928 is displayed in a feedback message choice selection area 920. The feedback message choice selection area 920 can be a fixed or floating overlay on the displayed digital media asset 910. The overlay can be opaque or semi-transparent. In another embodiment, the feedback message choice selection area 920 is displayed in an area of the display screen 40 separate from the displayed digital media asset 910. In yet another embodiment, the feedback message choice selection area 920 is displayed on a separate display or display device (not shown).

The feedback message choice selection area 920 of FIG. 9A shows the set of feedback message choices that can be selected by the user of the digital image display device 10. The particular feedback message set 921 is determined responsive to the individual who provided the displayed digital media asset 910. In this example, “Mike” is the individual who provided the image, as indicated by the “source” metadata for Image #9 in FIG. 6. The feedback message choice selection area 920 includes four feedback message choices: a “Thanks for sharing, Bro” feedback message choice 922, a “Wish I was there, Mike” feedback message choice 924, a “So proud!” feedback message choice 926, and a “My, the kids are growing” feedback message choice 928, which can be selected using selectable buttons to the left of each of the feedback messages. It will be recognized that some of these feedback messages are specific to the particular individual who provided the particular displayed digital media asset 910. If the same digital media asset were provided by a different individual, then the method of the present invention would provide a different feedback message set 921 appropriate to the different individual.

It will be understood that the digital image display device 10 may employ various types of user input interfaces block 30 that can be used by the user to select a particular one of the set of feedback message choices. For example, in some embodiments a touch screen user interface can be used. Alternatively, arrow navigation keys and a selection key can be used to navigate to and select the icon for a particular feedback message choice. In other embodiments, the digital image display device 10 could include a microphone and voice recognition algorithm, and the user could speak one or more words related to a particular feedback message.

FIG. 9B depicts a second example of a user interface 902 which is used to display a particular feedback message set 931 on the display screen 40. The particular feedback message set 931 includes feedback message choices 932, 934, 936 and 938 is displayed in a feedback message choice selection area 930. The user interface 902 also includes a displayed digital media asset 910, which in this example is the same digital media asset used in the example of FIG. 9A. However, the feedback message set 931 in this case is different than the feedback message set 921 of FIG. 9A because in this case the set of feedback message choices is determined responsive to the subject of the displayed digital media asset 910. In this example, “Matt” is the subject of the image, as indicated by the “subject” metadata for Image #9 in FIG. 6. The feedback message choice selection area 930 includes four feedback message choices: a “Great picture of Matt!” feedback message choice 932, a “Hope he had a fun birthday” feedback message choice 934, a “What a great smile!” feedback message choice 936, and a “My, Matt is growing fast” feedback message choice 938, which can be selected using selectable buttons to the left of each of the messages.

It will be understood that the feedback message choice 932 can be determined by determining that the subject of the displayed digital media asset 910 is a person, and then appending the name of the person (i.e., “Matt”) to the end of a generic message “Great picture of . . . ”. It will be understood that the feedback message choice 934 can be determined by determining that the capture date of the picture in the metadata of the displayed digital media asset 910 (i.e., December 5) corresponds to the birthday of the subject of the picture (i.e., “Matt”). It will be understood that the feedback message choice 936 can be determined by determining that the subject of the displayed digital media asset 910 is a person who is smiling, using face detection and smile detection algorithms. It will be understood that the feedback message choice 938 can be determined by determining that the subject of the displayed digital media asset 910 is a baby or child using an appropriate image classification algorithm.

In some embodiments, icons can be used as a form of a feedback message. The icons can be used instead of, or in addition to, textual feedback messages. FIG. 9C depicts a third example of a user interface 904 which is used to display a particular set of feedback choices on the display screen 40 using icons. The user interface 904 also includes a displayed digital media asset 912, as well as a back button 946 that enables the user to cancel the feedback providing process. The particular set of feedback choices is displayed as a grid of three columns of “emoticons” 942, which are a type of icon used to express an emotion with a representation of a face, with four rows of emoticons 942 in each column. Adjacent each column of emoticons 942 is a column of corresponding text feedback messages 944.

FIG. 9C shows particular set of twelve feedback message choices that can be selected by the user of the digital image display device 10. The particular set of feedback message choices in FIG. 9C can be used for a default fixed feedback message set, as was described earlier in relation to the embodiment of the determine feedback message set step 315 of FIG. 8A.

FIG. 9D depicts a fourth example of a user interface 906 which is used to display a particular set of feedback message choices on the display screen 40. The user interface 906 also includes the displayed digital media asset 912. The particular set of feedback choices is again displayed as a grid of three columns of emoticons 942, with four rows of emoticons 942 in each column, using the same set of emoticons 942 shown in FIG. 9C. Adjacent each column of emoticons 942 is a column of corresponding text feedback messages 948, many of which are different than the text feedback messages 944 shown in FIG. 9C. These particular text feedback messages 948 are determined responsive to the individual who provided the displayed digital media asset 912 (in this case, the sister of the user, i.e., “Sis”) or the subject of the displayed digital media asset 912 (e.g., “Wish I were there for Christmas”), or both.

It will be understood that small facial images of the user of the digital image display device 10 exhibiting different facial expressions could be used in place of the emoticons 942 shown in FIGS. 9C and 9D. It will be further understood that these small facial images could be responsive to the identity of the user of the digital image display device 10. For example, the digital image display device 10 could be used by two different users, “Ken” and “Susan,” and the set of feedback message choices displayed in the user interface 906 could be responsive to the identity of the user. In this example, two or more different sets of small facial images exhibiting different facial expressions can be stored in the non-volatile storage block 22 of the digital image display device 10 for each of two or more different users. The user at a particular time can be identified as described earlier, and the appropriate set of feedback message choices can be determined for the identified user of the digital image display device 10, so that the feedback message choices include an identification of the user of the digital image display device 10. It will be understood that in alternative embodiments, text can be used to provide feedback message choices which include identification of the user of the digital image display device 10.

In provide feedback message step 330 of FIG. 5, the digital image display device 10 uses the network interface block 34 to provide an indication of the selected feedback message to the individual who provided the digital media asset, or to an account associated with the individual who provided the digital media asset. It will be understood that the indication of the feedback message can be provided in many different ways. For example, it can include a text message, or an image, such as a smiling picture of the user or an emoticon. In some embodiments, rather than providing the feedback message itself, the provide feedback message step 330 can provide a data value indicating which of a standard set of feedback messages was selected.

Digital media assets shared over the network interface block 34 preferably include metadata providing an identification of the individual who shared the digital media asset, as well as the sharing method (e.g., E-mail, Facebook, Flickr, or Kodak Gallery) by which the digital media asset was received. In a preferred embodiment, the provide feedback message step 330 provides the indication of the selected feedback message to the individual who shared the digital media asset using the same sharing method that was used to provide the digital media asset. For example, if the digital media asset was received from a particular individual using E-mail, the feedback message is provided to the particular individual by sending an E-mail message. Similarly, if the digital media asset was received from a particular individual using a Facebook sharing method, the feedback message is provided to the Facebook account associated with the particular individual.

For the case where the shared digital media asset's associated sharing method is Facebook, a public application programming interface (Facebook API) is provided for posting feedback messages on a Facebook supplied image. The provide feedback message step 330 would then supply the selected feedback message to Facebook to provide to the Facebook user's account over the network interface block 34 using the Facebook API.

It will be understood that the methods for determining and using a particular set of feedback message choices responsive to the determined individual who provided a digital media asset can be provided using digital image display systems other that the one depicted in FIG. 3. For example, a personal computer connected to the Internet can be used to obtain digital media assets and metadata from a variety of individuals that are provided, for example, by E-mail server 140 or content providing systems 150 such as Facebook. The personal computer can display a digital media asset and provide feedback choices responsive to the determined individual who provided the digital media asset. The personal computer can then receive input from the user, via any user interface included as part of the personal computer, so that the user can select a particular one of the set of feedback message choices. The personal computer can then use its network connection to provide an indication of the selected feedback message to the individual who provided the digital media asset, or to an account associated with the individual who provided the digital media asset.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

A computer program product can include one or more non-transitory storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

### PARTS LIST

10 digital image display device
20 central processor
21 real-time clock
22 non-volatile storage block
24 buffer memory block
30 user input interfaces block
31 user buttons
32 media interface block
33 interface connector
34 network interface block
40 display screen
42 display compensation block
44 speaker(s)
46 audio codec block
50 power supply
52 frame surround
54 sliders
80 graphical user interface
82 play all icon
84 play recent icon
86 recently received assets box
92A person icon
92B person icon
92C person icon
92D person icon
92E person icon
92F person icon
92G person icon
94A recently received assets box
94B recently received assets box
94C recently received assets box
102 routing server
104 action logging server
106 authentication server
110 content and configuration server
120 web page server
122 administration configuration interface
124 web pages user interface
130 digital image and metadata content storage
140 E-mail server
150 content providing system
152 external content media server
154 external content host
156 external digital image and metadata content
200 obtain list of digital media assets step
205 read next digital media asset step
210 decompress data step
215 resize image for display step
220 compensate image data for display step
225 display image step
230 respond to user interface inputs step
235 wait to display next digital media asset step
250 identify server(s) step
255 obtain security code token step
260 obtain and store new content step
265 obtain configuration information step
300 receive digital media assets step
302 set of digital media assets
305 display digital media asset step
310 displayed digital media asset
315 determine feedback message set step
317 feedback message set
320 display feedback message choices step
325 receive user input step
327 feedback message
330 provide feedback message step
700 collection of digital media assets
710 digital media asset
720 metadata
800 fetch fixed feedback message set step
810 determine individual step
815 individual
820 does message set for individual exist test
830 generate feedback message set for individual step
840 fetch feedback message set for individual step
850 determine image subject step
852 image subject
855 classify image step
857 image class
860 does message set for image class exist test
870 generate feedback message set for image class step
880 fetch feedback message set for image class step
900 user interface
902 user interface
904 user interface
906 user interface
910 displayed digital media asset
912 displayed digital media asset
920 feedback message choice selection area
921 feedback message set
922 feedback message choice
924 feedback message choice
926 feedback message choice
928 feedback message choice
930 feedback message choice selection area
931 feedback message set
932 feedback message choice
934 feedback message choice
936 feedback message choice
938 feedback message choice
942 emoticons
944 text feedback messages
946 back button
948 text feedback messages

1. A digital image display device for displaying a collection of digital media assets, comprising:
a display screen;
a processor;
a network connection for receiving digital media assets, and for providing feedback related to the received digital media assets;
an image memory for storing the received digital media assets;
a user interface for receiving input from a user of the digital image display device; and
a processor-accessible program memory storing executable instructions for causing the processor to execute the steps of:
receiving a set of digital media assets using the network connection and storing the received set of digital media assets in the image memory;
displaying one of the digital media assets on the display screen;
identifying a subject depicted in the displayed digital media asset;
determining a particular set of feedback message choices responsive to the identified subject, wherein different sets of feedback message choices are determined for different identified subjects;
displaying the particular set of feedback message choices on the display screen;
receiving input from the user of the digital image display device via the user interface to select a particular one of the displayed set of feedback message choices; and
using the network connection to provide an indication of the selected feedback message.

2. The digital image display device of claim 1 wherein the indication of the selected feedback message is provided to a particular individual who provided the digital media asset, or to an account associated with the particular individual who provided the digital media asset.

3. The method of claim 1 further including receiving and storing a set of metadata associated with the received set of digital media assets.

4. The method of claim 3 wherein the set of metadata includes information providing an indication of the subjects depicted in at least some of the received digital media assets, and the wherein the subject depicted in the displayed digital media asset is determined using the received metadata.

5. The method of claim 4 wherein the metadata associated with a particular digital media asset includes the identity of a person depicted in the particular digital media asset, and wherein the identified subject is the depicted person.

6. The method of claim 1 wherein the subject depicted in the displayed digital asset is a person, and wherein the person is identified using a face recognition algorithm.

7. The digital image display device of claim 1 wherein particular set of feedback message choices includes feedback messages that have been previously provided for other digital media assets including the same subject.

8. The digital image display device of claim 7 wherein at least some of the previously provided feedback messages were provided using a system other than the digital image display device.

9. The digital image display device of claim 7 wherein the previously provided feedback messages were provided by individuals different than the user of the digital image display device

10. The digital image display device of claim 1 wherein the determination of the set of feedback message choices is also responsive to the identity of an individual who provided the displayed digital media asset.

11. The digital image display device of claim 1 wherein the determination of the set of feedback message choices is also responsive to the identity of the user of the digital image display device.

12. The digital image display device of claim 11 further including an image capture device, and wherein the identity of the user of the digital image display device is determined by applying a face recognition algorithm to an image of the user captured using the image capture device.

13. The digital image display device of claim 11 wherein the identity of the user of the digital image display device is supplied using the user interface.

14. The digital image display device of claim 11 wherein the identity of the user of the digital image display device is determined using a fingerprint scanner.

15. The digital image display device of claim 11 wherein the feedback message choices include an identification of the user of the digital image display device.

16. The digital image display device of claim 11 wherein the set of feedback choices are determined responsive to a relationship between the user of the digital image display device and the individual who provided the displayed digital media asset.

17. The digital image display device of claim 1 wherein the set of digital media assets are received using an E-mail sharing method, a social networking website sharing method, a digital image sharing website sharing method, a web browser upload sharing method or a direct network upload sharing method.

18. The digital image display device of claim 1 wherein the received digital media assets are digital still images or digital video images captured using a digital camera, or are scans of photographic prints or film captured using a digital image scanner.

19. The digital image display device of claim 1 wherein the network connection is a wireless network connection.

20. The digital image display device of claim 1 wherein the user interface includes a touch screen, a pointing device, one or more touch strips, one or more buttons, a remote control, a gesture recognition interface or a voice recognition interface.

21. The digital image display device of claim 1 wherein at least some of the displayed feedback choices are represented using icons.

22. The digital image display device of claim 21 wherein at least one of the icons is an emoticon.

23. The digital image display device of claim 21 wherein at least one of the icons includes an image of the user of the digital image display device.

24. The digital image display device of claim 1 wherein the user interface is a touch screen interface, wherein the feedback choices are represented using icons, and wherein the user provides input by touching the icon corresponding to the particular one of the feedback messages.

25. A method for providing a feedback message related to a digital media asset, comprising:
using a network connection to receive a digital media asset;
storing the received digital media asset in an image memory;
displaying the received digital media asset on a display screen;
identifying a subject depicted in the displayed digital media asset;
determining a particular set of feedback message choices responsive to the identified subject, wherein different sets of feedback message choices are determined for different identified subjects;
displaying the particular set of feedback message choices on the display screen;
receiving input from a user via a user interface, the input indicating a selection of a particular one of the displayed set of feedback message choices; and
using the network connection to provide an indication of the selected feedback message.
